(19) United States
(12) Patent Application Publication
(10) Pub. No.: US 2013/0047072 A1
(43) Pub. Date: Feb. 21, 2013

(54) PROGRESSIVE PRESENTATION OF DOCUMENT MARKUP

(71) Applicant: Jonathan Bailor, Bellevue, WA (US)

(72) Inventor: Jonathan Bailor, Bellevue, WA (US)

(73) Assignee: MICROSOFT CORPORATION, Redmond, WA (US)

(21) Appl. No.: 13/213,288

(22) Filed: Aug. 19, 2011

(51) Int. Cl. G06F 17/00

(52) U.S. Cl. 715/234

(57) ABSTRACT

Document markup is presented in a progressive manner by providing a view that avoids impact of the markup on the document body by abstracting away the markup as “hints”. The hints may be actionable elements presented in conspicuous locations of the document view and provide a window into the detailed markup being hinted at. Users may be enabled to toggle on and off the details of the markup abstracted away by any particular hint.

### BACKGROUND

Document editing applications such as spreadsheet applications, word processing applications, presentation applications, and other similar ones used for creating and editing a documents enable users to create, edit, store, and share a wide variety of documents with a wide range of features providing different capabilities. Many documents are edited numerous times after their creation, and keeping track of changes made to the document may be important for some purposes. For example, in collaborative authoring environments, authors may work on the same document making different changes. The ability to track changes may increase an efficiency of the collaborative work. Even when a user is modifying a document by himself/herself, change history of the document may provide valuable information to the user.

In conventional applications, documents containing markup—comments and tracked changes—typically present all users will all markup information all the time. This may lead users to hide all markup information so they can read the document efficiently. Heavy markup may detract from the reading experience. On the other hand, document markup also adds useful data during the reading experience. Thus, the all-or-nothing approach for presenting document markup degrades user experience.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to presenting document markup in a progressive manner. According to some embodiments, a view may be provided that avoids impact of markup on the document body by abstracting away the markup as “hints”. The hints may be actionable elements presented in conspicuous locations of the document view and provide a window into the detailed markup being hinted at. Users may be enabled to toggle on and off the details of the markup abstracted away by any particular hint.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a comparison of example conventional markup and abstracted markup according to some embodiments on a word processing document;

FIG. 2 illustrates examples of hints in “simple” or abstracted view and in markup view;

FIG. 3 illustrates examples of progressive presentation of different types of markup in abstracted and markup views;

FIG. 4 illustrates an example of progressive markup presentation on a document in a collaborative authoring environment according to other embodiments;

FIG. 5 illustrates the screenshot of an example user interface for configuring progressive presentation of markup;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of presenting document markup in a progressive manner according to embodiments.

### DETAILED DESCRIPTION

As briefly described above, document markup may be abstracted away using hints in a simple markup view avoiding detraction from a body of the document. Tracked deletions are an illustrative example. The more tracked deletions exist in a document, the less what is presented on the page is what is actually presented by the document. Details of the markup may be provided progressively as the user selects or indicates interest in individual hints.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing document processing services. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

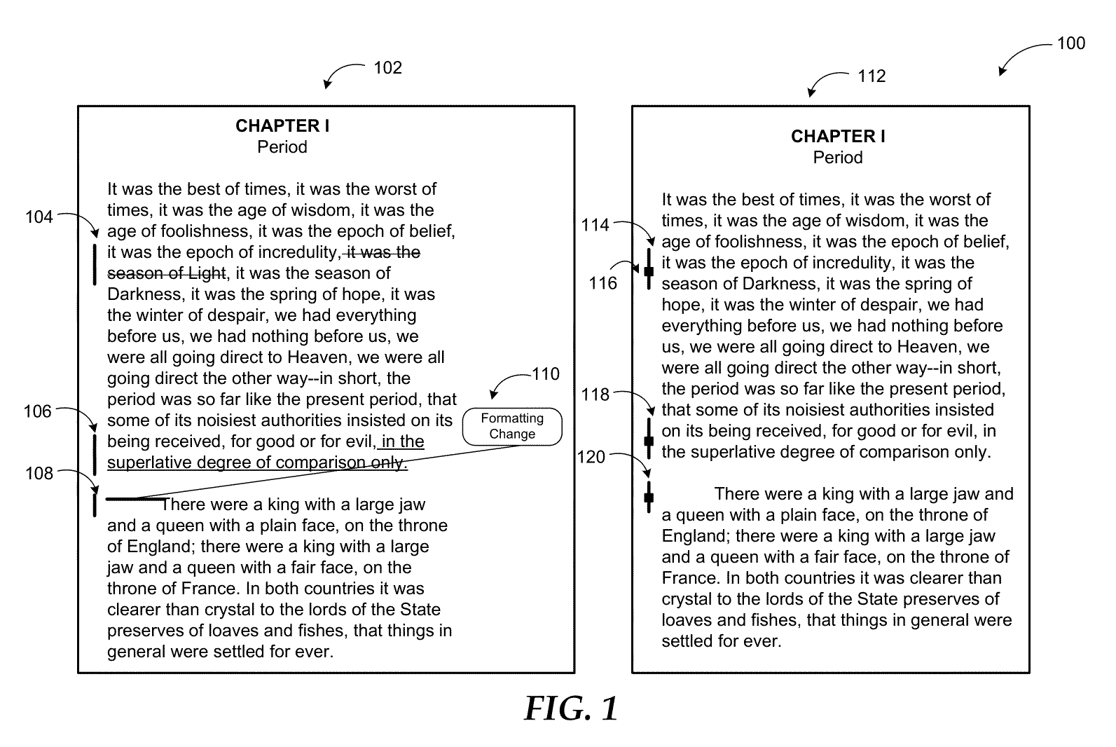

FIG. 1 illustrates a comparison of example conventional markup and abstracted markup according to some embodiments on a word processing document. As illustrated in diagram 100, a conventional markup view 102 may present changes such as deletions with a strike-through font style and an indicator bar 104 along one edge of the document, insertions with an underline font style and associated indicator bar 106, and formatting changes with a graphical element and associated indicator bar 108 along the edge of the document. In addition, callout balloons (110) may also be used to describe the change. While the changes in the example view are minimal, in a document with a large number of changes, the markup may detract from the document content.

Abstracted view 112 is a markup presentation according to some embodiments. In this view, the changes to the content are the same as in conventional markup view 102. As shown in the figure, the details of the changes are not displayed. Instead, “hints” or actionable indicator elements 114, 118, and 120 are used to indicate to the user the locations of the changes in the document. As shown further below, the details of the changes may be presented progressively if a user selects one of the hints or hovers over them.

The hints may be any graphical element including, but not limited to, bars, icons, graphical element combinations, etc. In the example abstracted view 112, hints are represented by a bar (e.g., 114) and rectangle (116) combination. A number of color, graphical element, shading, and similar schemes may be used to indicate different types of changes as discussed in more detail below.

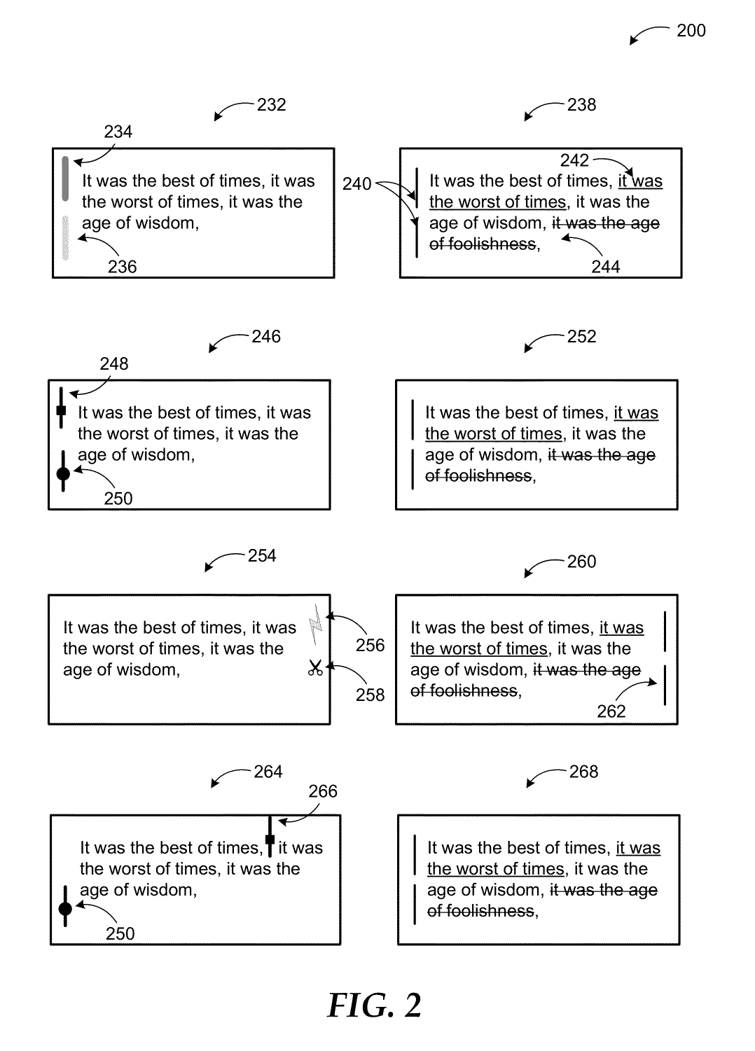

FIG. 2 illustrates examples of hints in “simple” or abstracted view and in markup view. As mentioned above, a variety of color, graphical, and shading schemes may be employed to provide information associated with changes in displaying hints.

The first example in diagram 200, illustrates use of a color scheme. In abstracted view 232, an insertion change is indicated by an indicator bar 234 in one color and a deletion change is represented by another indicator bar 236 in another color. The same content is shown with the changes in markup view 238. Insertion 242 is emphasized by an underline font style and deletion 244 is emphasized by a strike-through font style. The indicator bars 240 hinting at the changes are no longer colored and they are thinner than the abstracted view indicator bars 234, 236.

Abstracted view 246 illustrates a different scheme for the hints, where a combination graphical scheme is used to provide additional information. In the example scheme, indicator bar 248 includes a rectangle on it indicating an insertion change, while indicator bar 250 includes a circle on it indicating a deletion change. In other embodiments, other graphical shapes or forms may be used. The scheme may also be extended for providing further information. For example, the shapes on the indicator bars may be empty or full representing a different state or information in each case. The corresponding markup view 252 is similar to the markup view 238 with the details shown using different font styles.

Abstracted view 254 illustrates yet another scheme for providing hints. In this particular example, icons 256 and 258 represent insertion and deletion changes. Any icons may be used to represent different changes. Markup view 260 is similar to markup views 238 and 252 showing the details of the hinted changes using underline and strike-through font styles. Also, differently from previous examples, the hint icons 256, 258 and the indicator bars 262 are along a right edge of the document. The placement of the hints may be based on user preference or automatic depending on a document type (e.g., word processing documents in a right-to-left alphabet may automatically include the hints along the right edge).

In abstracted view 264, indicator bar 250 is in a similar location and represents the same deletion action as in abstracted view 246. Differently from abstracted view 246, however, in this example, indicator bar 266 representing an insertion action is placed at the beginning of the inserted content within the text. In other embodiments, the indicator bar (or equivalent icon) may be placed at the end, in the middle, or another suitable place of the inserted/deleted/moved content. Markup view 268 displays the details as in the above examples.

In abstracted view, details of individual changes may be presented upon detecting the user's interest on a hint. The user's interest may include selection of a hint (e.g., clicking on the indicator bar, selecting the indicator bar by gesture or touch, etc.) or a temporary action such as hovering of a pointer over the indicator bar. In the latter case, the details may be presented temporarily until the user moves on according to some embodiments. Alternatively, an indication of the change such as highlighting the changed content area or a callout balloon indicating type of change may be displayed in response to a hover action as opposed to the full details that may be presented in response to a selection action. Moreover, the hints may be displayed along a left or right edge of the document, or in some cases at select locations within the text.

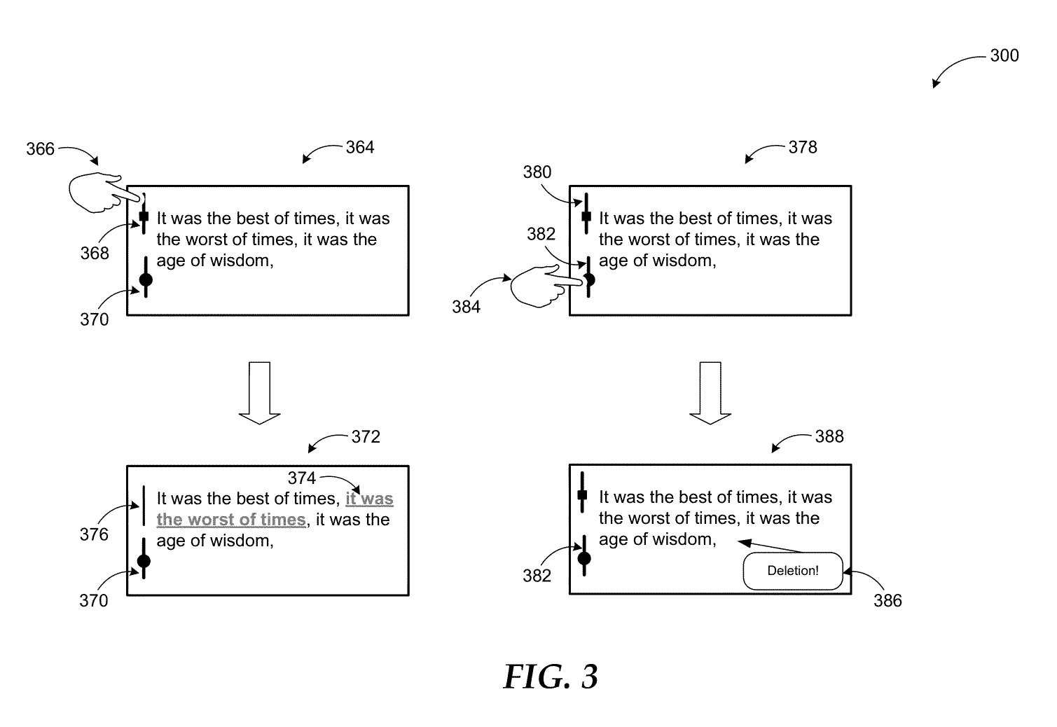

FIG. 3 illustrates examples of progressive presentation of different types of markup in abstracted and markup views. Diagram 300 shows two examples of progressive presentation. Of course, other presentations may be implemented using the principles described herein.

In the first example, abstracted view 364 includes two hints 368 and 370 representing an insertion and a deletion change according to a combination graphical scheme. Upon detecting a user selection (e.g., clicking) of hint 368, the view changes the displayed content showing the insertion change 374 in partial markup view 372. While hint 370 remains the same, the hint of the insertion change is modified to thin indicator bar 376 since the change is now displayed in detail.

In the second example, the same document content is used in abstracted view 378 with hints 380 and 382. This time, the user hover over (384) hint 382 representing the deletion change. In response, a callout balloon 386 is displayed in partial markup view 388 notifying the user that a deletion has occurred at the indicated location. In this case, the hint 382 is not changed, because the details of the change are not yet presented. The presentation is a temporary one as the hovering action is also temporary. If the user were to select hint 382, then the details may be displayed similar to partial markup view 372. Thus, progressive presentation of markup may be in stages, temporary and persistent.

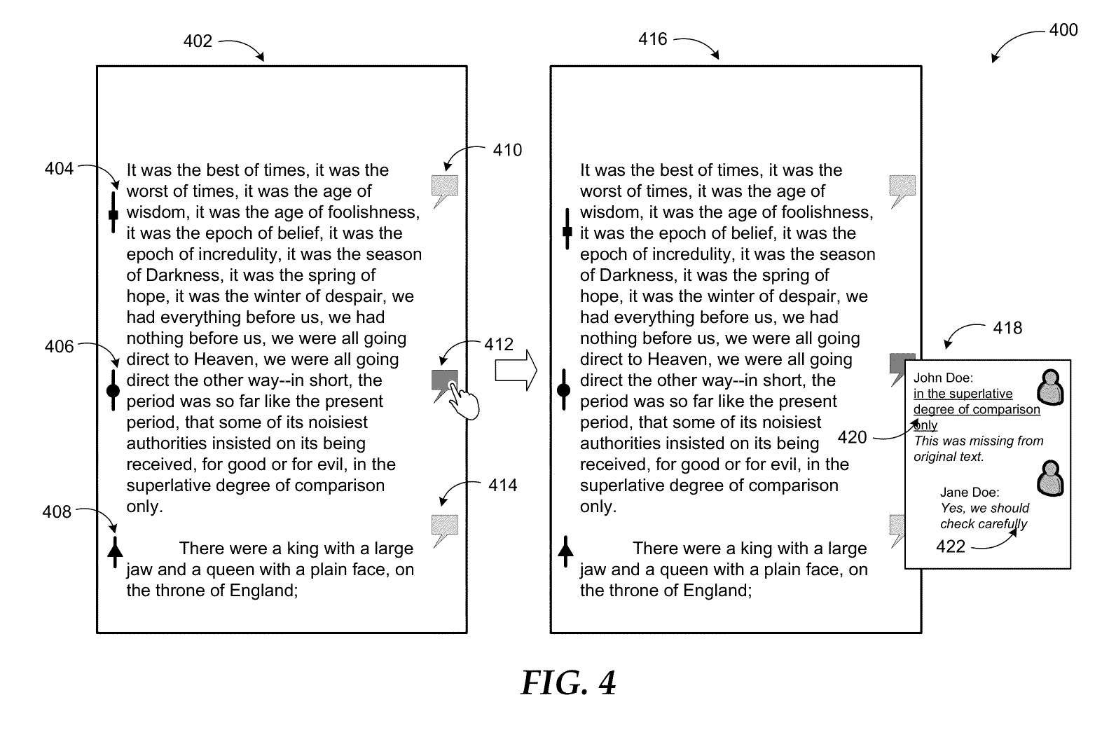

FIG. 4 illustrates an example of progressive markup presentation on a document in a collaborative authoring environment according to other embodiments. Presentation of tracked changes may also be progressive in a collaborative environment as shown in diagram 400.

Abstracted view 402 includes example hints 404, 406, and 408 according to a combined graphical scheme as discussed previously. In a collaborative environment, each of these changes may be made by a different person, while the document is stored by a server and accessed by the different users. In addition to the hints, abstracted view 402 also includes icons 410, 412, and 414 representing collaborative authoring information. The collaborative authoring information may include an identity of a user making a particular change, time/date of the change, or even an exchange of messages between the users about the change. Thus, a color, graphical, or shading scheme may be employed to indicate a source of the change or other attribute of the collaborative authoring information (e.g., each color may represent a different user).

In partial markup view 416, in response to a user selecting collaborative authoring information icon 412, details 418 of the collaborative authoring information are displayed. The displayed information includes an identity of the user making the change, the insertion change 420 itself using underline font style, and a comment from the user about the change (in italic font style). The displayed information further includes a response comment 422 from another user. The exchanges in collaborative environment may provide valuable information to users about the history of the document. However, when all are displayed reading the document may become a burdensome and difficult task. By abstracting collaborative information in a similar manner to the markup data, documents may become efficiently readable while retaining details about the change history of the document for on-demand presentation to a user.

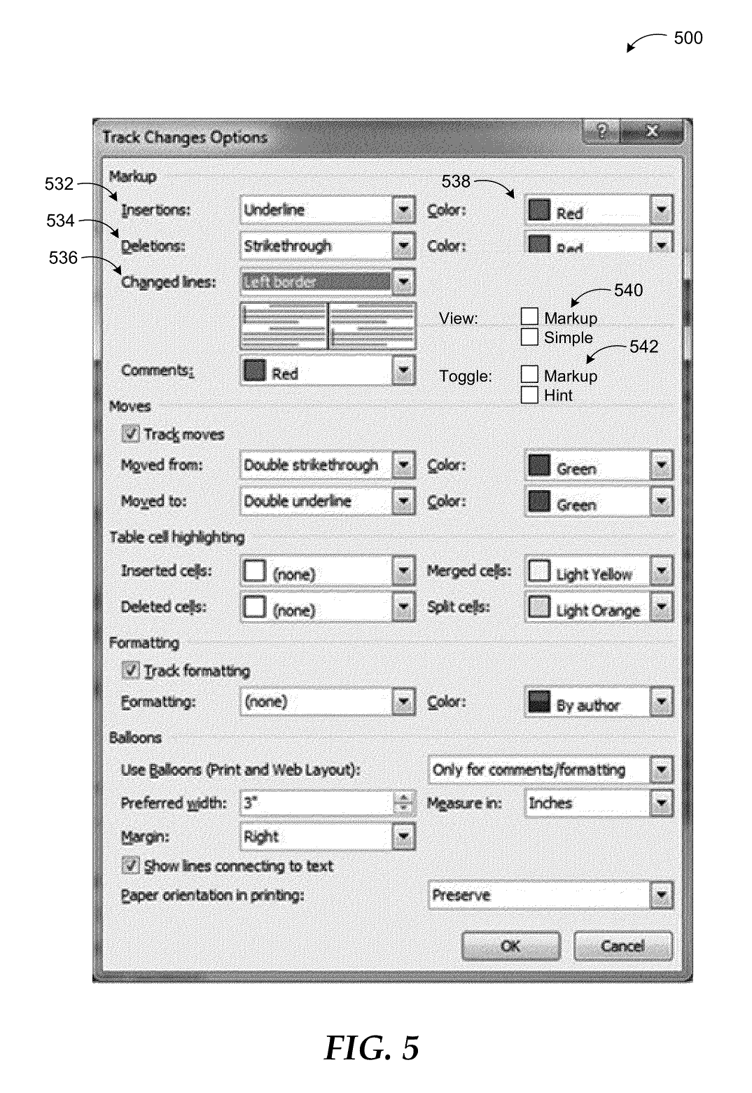

FIG. 5 illustrates the screenshot of an example user interface for configuring progressive presentation of markup. Screenshot 500 is intended to illustrate how markup presentation configurations may be defined / modified by a user in a document application.

As discussed above, the document application enabling editing of documents with change tracking and presentation may be a locally installed or hosted application capable of processing word processing documents, spreadsheets, presentation documents, emails, calendars, and comparable documents. A user interface such as the one shown in screenshot 500 may be presented to a user to configure markup presentation rules. The configurations may include presentation styles for different changes such as insertions 532, deletions 534, and line changes 536. Along with the different styles for selection, color schemes 538 may be provided in displaying markup.

A number of other configurations such as content move tracking, table cell change tracking, and format tracking may also be configured through the same user interface. In a document application according to embodiments, the user may be provided with a choice to between a simple view, where only hints of changes are presented, or a markup view, where details of the changes are presented (540). Another choice may be for toggling between markup and hint (542) enabling the user to select whether they want to see the hints or change details when they toggle on a given changed portion.

In addition to configuration of markup presentation through a special user interface such as the one in screenshot 500, users may be enabled to define their own rules by selecting among textual description of the available rules or inserting new rules themselves, automatically determining applicable choices based on user credentials (e.g., a supervisor may have permission to see all markup details, while a supervisee may be provided limited view of the details), or based on application type (e.g., a thin client may present a subset of the functionality, while a thick client application may present full functionality.

The example systems in FIG. 1 through 5 have been described with specific example elements, markup types, documents, and configurations. Embodiments are not limited to systems according to these examples. A system for progressively presenting document markup may be implemented in configurations employing fewer or additional components and performing other tasks. Furthermore, specific protocols and/or interfaces may be implemented in a similar manner using the principles described herein.

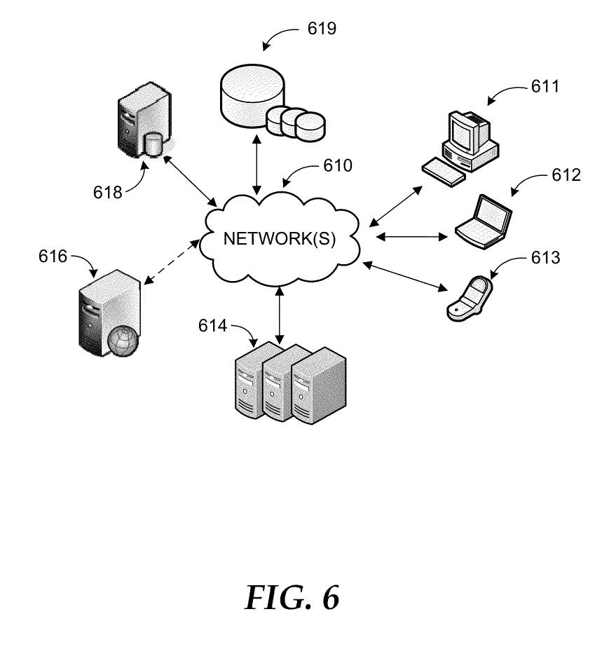

FIG. 6 is an example networked environment, where embodiments may be implemented. A system for progressive presentation of document markup may be implemented via software executed over one or more servers 614 such as a hosted service. The platform may communicate with client applications on individual computing devices such as a smart phone 613, a laptop computer 612, or desktop computer 611 (‘client devices’) through network(s) 610.

Client applications executed on any of the client devices 611-613 may facilitate communications via application(s) executed by servers 614, or on individual server 616. An application executed on one of the servers may provide a hosted document service enabling users to create, edit, and access otherwise a word processing documents, spreadsheets, presentation documents, and comparable ones through user interfaces provided by the client applications. The application may retrieve relevant data from data store(s) 619 directly or through database server 618, and provide requested services (e.g. document editing) to the user(s) through client devices 611-613.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to implement a platform for progressive presentation of document markup. Furthermore, the networked environments discussed in FIG. 6 are for illustration purposes only. Embodiments are not limited to the example applications, modules, or processes.

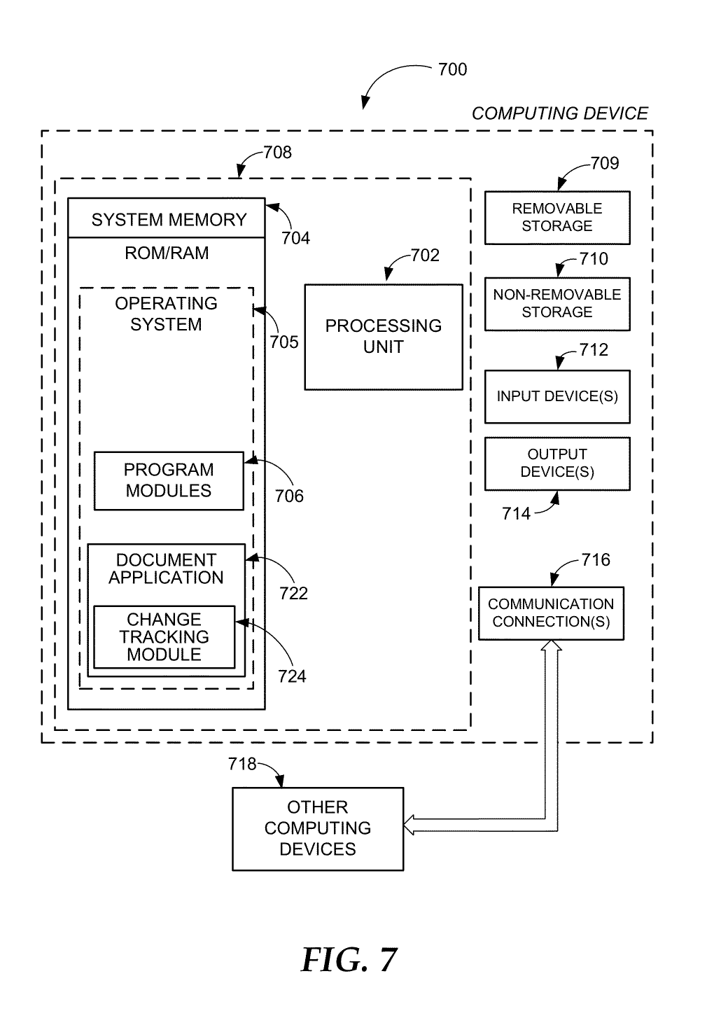

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be any computing device executing an application enabling editing of documents according to embodiments and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 706 suitable for controlling the operation of the platform, such as the WINDOWS ® operating systems from MICROSOFT CORPORATION of Redmond, Wash. The system memory 704 may also include one or more software applications such as program modules 706, document application 722, and change tracking module 724.

Document application 722 may enable users to create, edit, and otherwise process documents such as word processing documents, spreadsheets, presentation documents, emails, and similar ones. As part of the operations, document application 722 may enable users to track changes to an edited document. Change tracking module 724 may monitor and keep a history of changes to a document presenting those in a progressive manner (i.e., employing abstracted and markup views) to the user. Document application 722 and change tracking module 724 may be separate applications or integrated modules of a hosted service. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wired or wireless network in a distributed computing environment, a satellite link, a cellular link, a short range network, and comparable mechanisms. Other devices 718 may include computer device(s) that execute communication applications, web servers, and comparable devices. Communication connection(s) 716 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

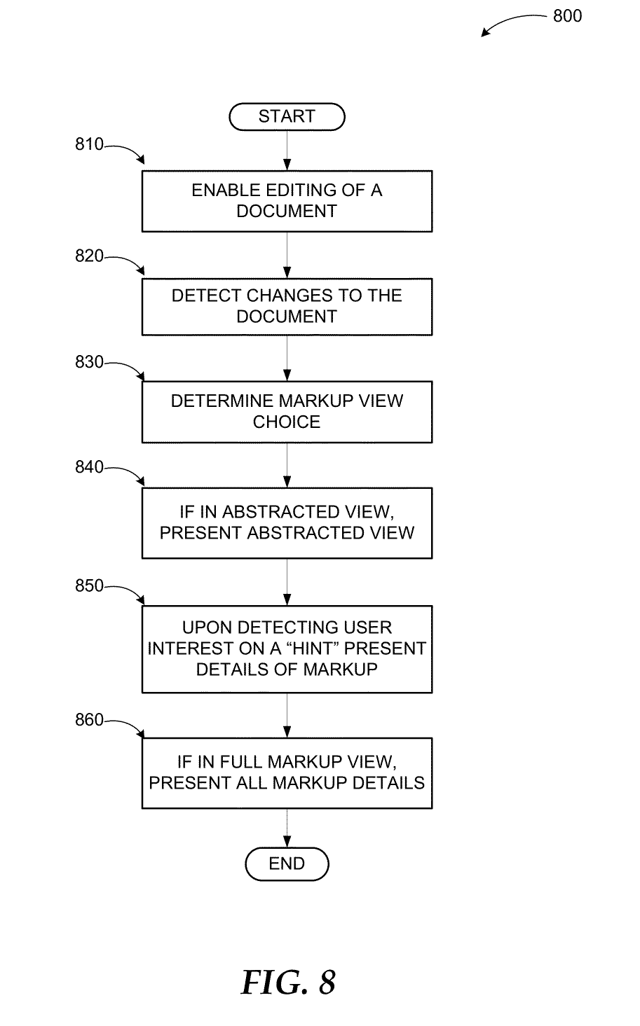

FIG. 8 illustrates a logic flow diagram for process 800 of presenting document markup in a progressive manner according to embodiments. Process 800 may be implemented on a computing device providing a document editing application.

Process 800 begins with operation 810, where the document application enables a user to edit a document making changes to content, formatting, etc. At operation 820, user made changes may be detected and tracked by the application. At operation 830, the application may determine a view choice. For example, the user may choose between a simple view, where only hints of changes are presented, or a markup view, where details of the changes are presented. The choices may be by default, user selection, or automatically determined based on context of usage, user credentials, application type, etc.

If an abstracted or simple view is the selected view type, the document application may present an abstracted view with hints at operation 840. In the abstracted view, the application may present details of individual changes upon detecting the user's interest on a hint at operation 850. The user's interest may include selection of a hint (e.g., clicking on it, selecting the hint by gesture or touch, etc.) or a temporary action such as hovering of a pointer over the hint. In the latter case, the details may be presented temporarily until the user moves on according to some embodiments.

If the selected view is full markup view, the user may be presented with details of all changes on the document at operation 860. Some additional details such as an author of the change, a time of the change, etc. may still be presented upon detecting the user's interest on a particular change.

The operations included in process 800 are for illustration purposes. Progressive presentation of document markup may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing progressive markup presentation, the method comprising:
detecting a change to a presented document;
determining a selected view;
if the selected view is full markup view, displaying markup details of changes in the presented document; and
if the selected view is abstracted view, displaying hints representing hidden markup details of the changes in the presented document.

2. The method of claim 1, further comprising:
upon detecting a user's interest on a displayed hint in the abstracted view, displaying markup details of a change represented by the displayed hint in a partial markup view.

3. The method of claim 2, wherein the user's interest on the displayed hint is detected based on one of: a hover over action and a selection action.

4. The method of claim 3, wherein the selection action is received through one of: a mouse click, a touch, and a gesture recognition.

5. The method of claim 1, wherein the hints comprise one or more form a set of:
indicator bars, graphical shapes, icons, and combinations of indicator bars and graphical shapes.

6. The method of claim 1, further comprising:
applying at least one from a set of: a color scheme, a graphical scheme, and a shading scheme to the hints in order to display attribute information associated with the markup.

7. The method of claim 6, wherein the attribute information includes one of a type of change and a source of change, and the type of change includes one from a set of: an insertion, a deletion, a move, a format change, a table cell change, a table row change, and a table column change.

8. The method of claim 1, further comprising:
displaying the hints in the abstracted view at a location comprising one of: a left edge of the displayed document, a right edge of the displayed document, and a place within a content of the document.

9. The method of claim 8, wherein the location of the hints is selected based on one of a user preference and a document type.

10. The method of claim 1, further comprising:
presenting a configuration menu user interface enabling a user to select among a plurality of markup display options and define one or more markup display rules

11. The method of claim 10, wherein the markup display options include a selection of a default view as one of the abstracted view and the full markup view.

12. A computing device for providing progressive markup presentation, the computing device comprising:
a memory storing instructions;
a processor coupled to the memory, the processor executing a document application that enables editing of documents, wherein the document application is configured to:
detect a change to a presented document;
determine a selected view;
if the selected view is full markup view, display markup details of changes in the presented document;
if the selected view is abstracted view, display hints representing hidden markup details of the changes in the presented document; and
upon detecting a user's interest on a displayed hint in the abstracted view, display markup details of a change represented by the displayed hint in a partial markup view, wherein the user's interest on the displayed hint is detected based on one of: a hover over action and a selection action.

13. The computing device of claim 12, wherein the document application is further configured to:
if the user interest is a hover over action, temporarily display a type of the change; and
if the user interest is a selection action, display the markup details.

14. The computing device of claim 13, wherein the document application is further configured to modify an appearance of the displayed hint upon displaying the markup details.

15. The computing device of claim 12, wherein the application is further configured to display the markup details employing at least one from a set of: a font style scheme, a color scheme, and a shading scheme.

16. The computing device of claim 12, wherein the application is further configured to:
display the hints along one of a right edge and a left edge of the document based on one of a user preference, an automatically detected document type, and an automatically detected content type.

17. The computing device of claim 12, wherein the document application is one of a locally installed application and a hosted application capable of processing at least one from a set of: a word processing document, a spreadsheet, a presentation document, an email, and a calendar.

18. A computer-readable memory device with instructions stored thereon for providing progressive markup presentation, the instructions comprising:
detecting a change to a presented document;
determining a selected view;
if the selected view is full markup view, displaying markup details of changes in the presented document;
if the selected view is abstracted view, displaying a first set of hints representing hidden markup details of the changes in the presented document, wherein the first set of hints comprise one or more form a set of: indicator bars, graphical shapes, icons, and combinations of indicator bars and graphical shapes;
applying at least one from a set of: a color scheme, a graphical scheme, and a shading scheme to the first set of hints in order to display attribute information associated with the markup; and
upon detecting a user's interest on a displayed hint in the abstracted view, displaying markup details of a change represented by the displayed hint in a partial markup view.

19. The computer-readable memory device of claim 18, wherein the instructions further comprise:
displaying a second set of hints to represent collaborative authoring information for a collaboratively authored document; and
employing at least one from a set of: a color scheme, a graphical scheme, and a shading scheme in conjunction with the second set of hints to indicate one of a source of a change and an attribute of collaborative authoring information.

20. The computer-readable memory device of claim 19, wherein the instructions further comprise:
upon detecting a selection of one of the hints from the second set of hints, displaying the collaborative authoring information that includes at least one from a set of: an identity of a user making the change, the change, and a comment from another user about the change.
